(19) United States
(12) Patent Application Publication
(10) Pub. No.: US 2012/0316996 A1
(43) Pub. Date: Dec. 13, 2012

(54) METHOD FOR MANAGING AN ONLINE MARKET AND ONLINE MARKET MANAGEMENT SYSTEM FOR PERFORMING THE METHOD

(75) Inventors: Youngin Shin, Santa Clara, CA (US); Seung Won Ha, Livermore, CA (US)

(73) Assignee: ORENGEO, INC., Milpitas, CA (US)

(21) Appl. No.: 13/154,500

(22) Filed: Jun. 7, 2011

(51) Int. Cl. G06Q 30/00

(52) U.S. Cl. 705/27.1

(57) ABSTRACT

An online market management system includes a Role Mapping Server, a Goods Posting Server and Revenue Sharing Server. The Role Mapping Server is configured to map a requester as a participant in a multi-layer and multi-branch growth model. Here, the multi-layer and multi-branch growth model is classified into a root belonging to a first layer, a leaf belonging to a bottom layer, and a branch belonging to an intermediate layer to be disposed between the root and the leaf. The Goods Posting Server is configured to post a good into a Platform. The Revenue Sharing Server is configured to share revenue generated in accordance with a sale of a corresponding good with a posting participant posting the good, a selling participant selling the good and a recruiting participant recruiting the selling participant when the good is sold, based on the multi-layer and multi-branch growth model.

### BACKGROUND OF THE INVENTION

1. Field of the Invention

Example embodiments of the present invention relate to a method for managing an online market and an online market management system for performing the method. Particularly, example embodiments of the present invention relate to a method for managing an online market capable of expanding a network of the online market and an online market management system for performing the method.

2. Description of the Related Art

Online marketplaces bring buyers and sellers together for the purpose of exchanging goods and or services and may do so in either an auction format, fixed price format or some combination of formats. In order to cover operating expenses and to generate profit, most online marketplaces have a fee structure for the buyers and or sellers including but not limited to listing fees and fees based on a percentage of the transaction amount.

There have been many online marketplace websites that have been developed including, but not limited to the App Store of Apple Inc. (Apple) which is part of its iTunes presence, and which is a widely-used market for mobile applications. Other major competitors that have begun online marketplaces or are in the process of establishing a marketplace include such global companies as Google Inc., Orange Inc. and Nokia Inc.

Apple's App Store is an application software download service which is part of Apple's iTunes program, or available separately, and is designed for Apple's proprietary mobile computing hardware (or iOS) devices, specifically the iPod (multimedia device), the iPad (tablet computer) and the iPhone (smart phone computing device) which are all manufactured by Apple Inc. and are designed to run the applicable Apple device-specific operating system. Apple is a company in this market for applications which are designed to run on these mobile devices using a set of open standards freely available to any software developer. The App Store was launched on Jul. 11, 2008 as part of an iTunes software update package. In the App Store, it is possible to download contents on a menu of iPhone, iPad or iPod via Wi-Fi, 3G or other comparable Internet connectivity service, or it is also possible to download App Store applications to a computer that may then transfer the program to one or more of these iOS devices.

Generally, a software program developer (or user), may develop an application program for the purposes of uploading to the App Store and then downloading to users. At the beginning of the process, the software developer must complete a contract with Apple which enables access to a software developing tool such as iPhone SDK, (which is controlled by Apple), that is needed in order to develop the application program. The software developer may sell, or distribute the developed application program through the App Store for a price or for free. The developer sets the application program's selling price, and Apple, charges a fee based on the sales revenue plus may also charge a hosting or listing fee. The commission and fees may be 30% of revenue, for example. Therefore, the developer's application is sold through a process which involves a host site and not through a direct relationship between the developer and the end user, which has the effect so as to potentially limit the marketing and selling interface between buyer and seller.

New entrants in the mobile platform markets competing against Apple, may take actions to compete in the marketplace, such as the opening of a new service platform, the opening of source code for various programs and or the discounting of fees. However, in order to remain globally competitive in the mobile platform marketplace, new entrants may employ various strategies beyond these steps.

New entrants may select lowering of fees as an entry strategy within the mobile platform markets, or other markets, however, this is likely to dramatically reduce revenue and profit and may also reduce the ability to invest marketing money to build up the brand value.

Generally speaking, many of these online marketplaces exist and operate with a single entity controlling the processes of listing or posting, selling and buying. Therefore, they operate a single marketplace where sellers and buyers may conduct transactions according to the framework set forth by the marketplace controlling entity.

### SUMMARY OF THE INVENTION

Example embodiments of the present invention provide a method for managing an online market capable of sharing revenue with online market participants.

Example embodiments of the present invention also provide an online market management system for performing the method.

According to one aspect of the present invention, there is provided a method for managing an online market. In the method, (a) a requestor as a participant is Mapped in a multi-layer and multi-branch growth model when a joining of an online market is requested by the requestor, here, the multi-layer and multi-branch growth model is classified into a root belonging to a first layer, a leaf belonging to a bottom layer, and a branch belonging to an intermediate layer between the root and the leaf; (b) a good is posted on a Platform when a good posting on a Platform provided to the participant is requested; and (c) a revenue generated in accordance with the selling of a good is shared with a Listing participant that Lists the good, a Selling participant that sells the good and a Recruiting participant that recruits the Selling participant when the good is sold, based on the multi-layer and multi-branch growth model.

In an example embodiment, the step (a) may includes (a-1) checking whether or not a recruiting participant that recruits a corresponding requestor exists in the model; (a-2) making a contract with a root manager and a corresponding requestor, when it is checked that the recruiting participant does not exist in the step (a-1); (a-3) Mapping a corresponding requestor in the multi-layer and multi-branch growth model as a leaf participant; and (a-4) providing the corresponding requestor with the Platform.

In an example embodiment, the step (a) may further include (a-5) checking whether or not a corresponding recruiting participant is a leaf participant; and if it is verified that the recruiting participant is a leaf participant in the step (a-1), then (a-6) raising the corresponding recruiting participant to a branch participant; (a-7) making a contract with a corresponding requestor and a corresponding recruiting participant; (a-8) Mapping a corresponding requestor in the multi-layer and multi-branch growth model as a leaf participant; and (a-9) providing the corresponding requestor with the Platform.

In an example embodiment, the step (c) may include (c-1) verifying a Listing participant that posts a sold good, the Selling participant that sells a corresponding good and the Recruiting participant that recruits a corresponding selling participant in the multi-layer and multi-branch growth model.

In an example embodiment, the step (c) may further include (c-2) sharing revenue with a corresponding Posting participant, a corresponding Selling participant and a corresponding Recruiting participant, in a case that the Posting participant, the Selling participant and the Recruiting participant are verified in the step (c-1).

In an example embodiment, the sub-layers may be classified into a high layer and a lower layer through a contracting conclusion subordinately.

In an example embodiment, the goods may be a Smartphone app.

According to another aspect of the present invention, an online market management system includes a Role Mapping Server, a Goods Posting Server and a Revenue Sharing Server. The Role Mapping Server is configured to map a requestor in a multi-layer and multi-branch growth model as a participant when a joining of an online market is requested by the requestor. Here, the multi-layer and multi-branch growth model is classified into a root belonging to a first layer, a leaf belonging to a bottom layer, and a branch belonging to an intermediate layer between the root and the leaf. The Goods Posting Server is configured to post a good into a Platform when a good posting is requested on a Platform provided to the participant. The Revenue Sharing Server is configured to share a revenue generated in accordance with a sale of a corresponding good with a posting participant that posts the good, a selling participant that sells the good and a recruiting participant that recruits the selling participant when the good is sold, based on the multi-layer and multi-branch growth model.

In an example embodiment, the Role Mapping Server may include a contract conclusion module, a platform providing module and a layer defining module. The contract conclusion module may be configured to make a contract with a root site business and a participant corresponding to a branch of a corresponding business, or to make a contract with a corresponding participant and a participant that recruits the corresponding participant. The Platform providing module may be configured to provide a Platform with a participant that a contract is completed and corresponding to a branch. The layer defining module may be configured to define a participant corresponding to a branch that a contract is concluded with a root site business or another participant that a contract is concluded with the corresponding participant as a lower layer.

In an example embodiment, the Revenue Sharing Server may include an Inquiring Module and a Sharing Module. The Inquiring Module may be configured to verify a posting participant that posts a sold good, inquire a selling participant that sells a corresponding good, and verify a recruiting participant that recruits a corresponding selling participant. The Sharing Module may be configured to share a revenue according to a good posting to a verified posting participant, share a revenue according to a good selling to an inquired selling participant, and share a revenue according to a good recruiting of the selling participant to an inquired recruiting participant.

In an example embodiment, the sub-layers may be classified into a high layer and a lower layer through a contracting conclusion subordinately.

In an example embodiment, a branch belonging to an uppermost layer may receive a Platform from the root through a contracting conclusion with the root.

In an example embodiment, a branch belonging to a bottom layer may provide a Platform to the leaf through a contracting conclusion with the leaf.

In an example embodiment, when one of the leaves recruits a requestor requesting an online market joining, a corresponding leaf may be raised as the branch, and a corresponding requestor may be mapped as the leaf.

In an example embodiment, the good may be a Smartphone app.

In an example embodiment, when an expected revenue as a result of selling the requested good from one of the posting participant, the selling participant and the recruiting participant, the online market management system may further include an Expected Revenue Calculation Server configured to calculate a corresponding expected revenue to provide a corresponding participant with the expected revenue.

In an example embodiment, a branch seller who has an inventory of goods and who does not have a selling capacity may obtain expected revenue defined as F(rα+γ)NP (wherein, ‘F’ is a fee per good, ‘r’ is the number of child branches extended from one branch, ‘α’ is a revenue sharing ratio for a recruiting activity, and ‘γ’ is a revenue sharing ratio for a posting activity.)

In an example embodiment, a branch seller who does not have an inventory of goods and who does have a selling capacity may obtain an expected revenue defined as F(rα+β)NP (wherein, ‘F’ is a fee per good, ‘r’ is the number of child branches extended from one branch, ‘α’ is a revenue sharing ratio for a recruiting activity, ‘β’ is a revenue sharing ratio according to a sales activity, ‘N’ is the total number of sites, and P=1/N2)

In an example embodiment, the expected revenue ratio of a root, a branch and a leaf may be defined as rα+1:(r−1)α+1:1−α (wherein, ‘r’ is the number of child branches extended from one branch, and ‘α’ is revenue sharing ratio for a recruiting activity), and ‘α’ is a variable that may be changed in order to control a revenue ratio between a branch and a leaf.

### BRIEF DESCRIPTION OF THE DRAWINGS

In this section, the above descriptions and explanations of the present invention including its features and advantages will become more apparent in the accompanying Figures and Drawings which describe detailed example embodiments of the present invention:

FIG. 1 is a diagram which outlines a summary structure of the online marketplace system the Internet and a wireless network in an example embodiment of the present invention;

FIGS. 2A to 2D are schematic diagrams illustrating relationships within the multi-layer and multi-branch model;

FIG. 3 is a schematic diagram illustrating the overall structure of the multi-layer and multi-branch growth model including detailed layers and nodes;

FIG. 4 is an overview of various systems, databases and servers that are used in the root site, including the Role Mapping Server, Goods Selling Server, Goods Posting Server, Revenue Sharing Server, Expected Revenue Calculation Server and Central Control Server.

FIG. 5 is a block diagram illustrating the Role Mapping Server pictured in FIG. 4;

FIG. 6 is a block diagram illustrating the Revenue Sharing Server pictured in FIG. 4;

FIG. 7 is a block diagram illustrating an example of an Internet shopping mall within a first branch group or layer of FIG. 1;

FIG. 8 is a flow chart which shows how many aspects of the marketplace are managed, including a user joining the marketplace, the user being mapped with the appropriate role and hierarchical position within the structure, the Selling of goods, the Listing of goods and the distribution of revenue in another example embodiment of the present invention;

FIG. 9A is an image of a graphical user interface (hereinafter referred to as “GUI”) within an example webpage of a root site;

FIG. 9B is an image of a sample webpage GUI used for joining and logging in to the system;

FIG. 9C is an image of a sample GUI webpage for a site wizard available to new users in order to establish a new site or sub-marketplace platform;

FIG. 9D is an image of a sample GUI webpage for selecting and naming web templates as an example sub-marketplace platform;

FIG. 9E is an image of a sample user's GUI webpage which provides an example of a new site or sub-marketplace platform;

FIG. 9F is an image of a sample Seller's GUI webpage for selling goods and is an example of a marketplace or sub-marketplace platform;

FIG. 9G is an image of a sample Lister's cross-posting GUI webpage and is an example of a marketplace or sub-marketplace platform;

FIG. 10 is a flow chart which shows the Mapping functions of the multi-layer and multi-branch growth model as pictured in FIG. 8; and

FIG. 11 is a flow chart illustrating the revenue sharing functions which correspond to the Listing, Selling and Recruiting activities of the model as pictured in FIG. 8.

### DETAILED DESCRIPTION OF THE INVENTION

An example embodiment of the present invention relates to a method for managing a marketplace and an online system for performing the method and the system for implementing said method which are described more fully hereinafter with accompanying examples and drawings which exhibit embodiments of the invention. The invention may, however, be embodied in many different forms and should not be construed as limited to the examples set forth herein. Rather, these examples are provided so that this disclosure will be thorough and complete, and will fully convey the scope of the present invention to those skilled in the art.

It will be understood that when an element or layer is referred to as being “on,” “connected to” or “coupled to” another element or layer, it may be directly on, connected or coupled to the other element or layer, intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and or” includes any and all combinations of one or more of the associated listed items.

It will be understood that, although the terms first, second, third etc. may be used herein to describe various elements, components, regions, layers and or sections, these elements, components, regions, layers and or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and or “comprising,” when used in this specification, specify the presence of stated features, integers, steps, operations, elements, and or components, but do not preclude the presence or addition of one or more other features, integers, steps, operations, elements, components, and or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

An example embodiment of the present invention relates to a method for managing a marketplace and an online system for performing the method. Furthermore an example embodiment of the present invention relates to a marketplace with specific rules for fees to be paid by sellers to other parties related to the sale if applicable. The method described within this document is separate from the online format for a marketplace; the method may be used online or with a traditional marketplace. An example embodiment of the present invention is the establishment of a marketplace mechanism that is used to compensate the owner of the marketplace for sales transactions that take place within that marketplace. Specifically, the marketplace may exist in an electronic format in an online network environment, and particularly the Internet. In an example embodiment of the present invention, the method may be used as part of an online environment which is provided by a specific website (the host) as part of an online service established by the host website.

In an example embodiment of the present invention, the model uses multi-layer and multi-branch elements which are structured in such a way so to as encourage and reward growth in the network by increasing rewards to more participants in the marketplace and by rewarding marketing activity which may lead to expansion of the number of participants in the marketplace over time.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise.

Within an example embodiment of the present invention, the nodes of the multi-layer and multi-branch model are classified as follows: a root, a branch or branches, and a leaf or leaves. Each node of the model, belongs to a pre-defined layer. The root belongs to the first or top layer; a branch is an intermediate layer between the root and the leaf; and the leaf is the last or bottom layer.

In order for the method of this embodiment, to be meaningful, it is necessary to understand the structures of the marketplace. At the top of the marketplace is a host marketplace, which is owned by the provider of the system, or host. The host is the owner of that top layer marketplace venue. Within the online context, the owner of the host market is the owner of the Internet site where the online marketplace is based. The host marketplace is therefore the root layer. It is possible for the host marketplace to have multiple roots, although logically, they are all still at the top layer since these roots are controlled by the single entity of the host owner.

In an example embodiment of the present invention, at the root level, the site platform has no parent relationships or earlier generations of relationships with other sites. The root level is by definition the parent of all first generation child sites which form underneath this top root layer. Furthermore, it has a grandparent relationship with the children sites of the first generation children sites. The first generation child sites then are by definition parent sites of their children sites. Sites are an independent structure of the marketplace and are not necessarily related to the site owner, with the exception of the host root site, which is providing the overall marketplace system within an example embodiment of the present invention. An individual party could own more than one site within the system of sites or marketplace platforms within an example embodiment of the present invention.

In an example embodiment of the present invention, within the model the term platform (hereinafter Platform), refers to a marketplace or sub-marketplace site where buying, selling, listing and or posting of goods and or services may occur. Users may gain access to ownership of their own platforms only by agreeing with a standard boilerplate terms of service contract that is provided by the host system within an example embodiment of the present invention. These standard contracts are used in order to gain access to use the website within an example embodiment of the present invention. Furthermore, these contracts are a necessary part of forming the relationship between the root site and the children of the root site as well as any other parent-child relationship between any branch node or leaf node within the model within an example embodiment of the present invention.

In an example embodiment of the present invention, the term recruiter (hereinafter referred to as “Recruiter”) within this model may be used to describe the parent in the parent-child relationship. Within the example embodiment within the model, the Recruiter may not need to perform any specific action in order to be a Recruiter beyond existing as the parent of the child. The child is therefore recruited by its parent through the initiation of the relationship between the parent and the child and the necessary corresponding contract within the example embodiment of the present invention. Hereinafter, the terms “Recruiter” and “Parent” are used interchangeably when describing parent-child relationships.

In an example embodiment of the present invention, there are three classes of participants involved in this model. The first class of participant is buyers. Buyers are not required to establish their own layer or marketplace within the model, but are not prohibited from doing so. Buyers are not represented in any layer of the model for buying-only activity within the embodiment. Within the online context, buyers are not creating their own customized online site or publicly-viewable online area.

The second class of participants in the model is Sellers within an illustrated embodiment. Sellers establish their own venue for selling goods or services, which may be referred to as their “sub-marketplace” within an illustrated embodiment of the present invention. The Seller is the owner of a “Seller” site. With the exception of the root host site, all Seller sites are children of a parent site. The Seller site may or may not have child or children sites. The Seller site is the site where a good or service is first made available for sale to a buyer within an illustrated embodiment of the present invention.

In an illustrated embodiment, a third class of participants in the model are users who do not buy or sell but instead directly establish the venue, or virtual online venue, where the sales transaction takes place. This third class of participants may also be referred to as “Listers.” This third class of participant the “Lister” in essence creates a marketplace within a marketplace, or “sub-marketplace” where goods or services are listed for sale in an illustrated embodiment. There is nothing to prevent this participant class from also buying and or selling. This third class “Lists” or “Posts” items for sale acting as a referral service to a “Seller” site. With the use of linking technology, the Listing site is essentially allowing a buyer, potential buyer or other user to view the item from the Listing site, when in fact the item represents an item that is visible on the Seller's site as well. It could also be described that the Lister is providing a window in order to see an item or items on a Seller's site. The Lister is the owner of the “Listing” or “Posting” site. The Lister may also have parent and or child relationships within the hierarchical structure (the root host site however may only have child relationships, although the root site may also function as a Lister) and within an example embodiment.

Within an illustrated embodiment as part of the overall system of a sales transaction, therefore, three types of participants are possible: a Seller, a buyer and in some cases a participant who is described as a “Lister.” A separate Listing site is not required in order for a sales transaction to occur as the transaction could occur on the Seller's site directly, and in this instance, the Seller's site is also considered to be a Listing site as it is its own Lister. A Lister has a relationship with either the buyer and or the Seller and functions as an intermediary between the two parties, although no active action may be required on the part of the Lister as the “Listing” is an inherent property of the system in an example embodiment. The Lister recruits either the buyer of the good, the Seller of the good, or both and may expand opportunities for the Seller. Listers may help to enable transactions between buyers and Sellers, which otherwise may not occur. Listers may or may not choose items to be sold that they feel are of interest to them, have high quality, and or good value. The Lister may act as an information service for both the buyer and Seller, which would then cause the network to tend to grow and potentially increase in sales activity. In an example embodiment of the present invention, the Lister therefore is performing a marketing activity for the Seller for those items which the Lister has posted on the Listing site.

In an example embodiment of the present invention, the sub-marketplace in the online marketplace format involves using web templates to create a customized version of a website, which becomes the “sub-marketplace” and which may or may not be involved in the sale transaction. Through the use of filters, individual preferences and research on the part of the Lister, the “sub-marketplace” receives sales listings or postings of goods and or services that are also viewable on a Seller's online site.

In an example embodiment of the present invention, a good is listed for sale in the marketplace (or sub-marketplace) and is available to be purchased by a buyer. A Lister who established a sub-marketplace may not need to perform any specific action as part of the Listing or posting process within an example embodiment. In an example embodiment of the present invention, through the use of general category settings or the enabling of specific filters, content may be pushed down from the host web site, to the sub-marketplace as part of the overall process. The host site is defined as the web site which manages all sub-marketplaces, participants, users, buyer and Sellers. The Lister may or may not have been directly involved in the specific sales Listing beyond overall design of the site (or sub-marketplace), and establishment of general settings, category settings, filters and or general vendor preferences.

In an example embodiment, a buyer purchases a good and revenue is generated, part of which may be fee revenue related to the sale. In an example embodiment of the present invention, the model details how fee revenue is shared between the Seller, the Parent of the Seller, and the Lister who established the marketplace, and which in some cases may also be the same party as the Seller or Parent of the Seller. If the Seller established the (sub-) marketplace, then the Seller is also the Lister and receives a percentage of fee revenue as part of the compensation distribution model. The method of fee revenue sharing (or distribution) is the central element of an example embodiment of the present invention.

For the purposes of this detailed description, the following outlines this overall method within an example embodiment: Step a) Participants are mapped within the model as either Sellers, Parents of a Seller (or Sellers), or Listers (establishers of a sub-marketplace or places), and these mappings correlate to the different node layers of the multi-layer and multi-branch model which are roots, branches or leaves; (note that buyers are not mapped unless also existing in one of the other three classes of participant); Step b) A Good or goods are Listed or posted within the marketplace and are available for purchase by a buyer; Step c) Revenue, including fee revenue is generated from the sale transaction and fee revenue is distributed as commission according to the model's formula between marketplace participants including the owner of the Selling site, the Parent of the Selling site and owner of the Listing site, if that owner is separate from the Selling or Parent site. Ownership of a site, or sub-marketplace is not necessarily related to three mappings within the model.

In an example embodiment, step (a) includes or may include (a-1) checking for the existence of a Parent of the new Participant; (a-2) making a contract between the root manager and the Participant if a Parent does not exist in the step (a-1); (a-3) mapping the new Participant in the multi-layer and multi-branch growth model as a leaf participant; and (a-4) providing the new Participant with the Platform.

In an example embodiment, step (a) may further include (a-5) checking whether or not the corresponding Parent is a leaf participant; (a-6) raising the corresponding Parent to a branch participant; (a-7) making a contract with the new Participant and its corresponding Parent; (a-8) Mapping a new Participant in the multi-layer and multi-branch growth model as a leaf participant; and (a-9) providing the new Participant with the Platform.

In an example embodiment, step (c) may include (c-1) verifying or determining the three participant Roles that may be involved in the model for a sales transaction: verifying the Seller who sells the good, verifying the Parent of the Seller, verifying the Lister who lists the good.

In an example embodiment, step (c) may further include (c-2) sharing revenue, including fee revenue between the Seller, the Parent of the Seller, and the Lister as each Role is verified within step (c-1).

Sub-layers may be classified into a higher layer and a lower layer through the contractual process once contracts are completed during the process of forming the marketplace or sub-marketplaces.

In an example embodiment of the present invention, an online market management system may include a Role Mapping Server, a Goods Posting Server and Revenue Sharing Server. The Role Mapping Server maps Participants in the multi-layer and multi-branch growth model. Here, the model classifies the following: the root belongs to the first or top layer; a branch is an intermediate layer between the root and the leaf; and the leaf is the last or bottom layer. The Goods Posting Server posts goods onto a Participant's Platform. The Revenue Sharing Server shares sales revenue including fee revenue between the Seller, the Parent of the Seller, and the Lister according the method of the multi-layer and multi-branch model.

In an example embodiment of the present invention, the Role Mapping Server may include a Contract Module, a Platform providing module and a layer defining module. The Contract Module may be configured to make contracts between the host marketplace root layer (or node) and new Participant nodes (which would be leaf nodes first but which could become Parent branch nodes), or to make contracts between Parent branch nodes and new Participant leaf nodes. If correct corresponding contracts are in place, the Platform providing module provides a Platform to a new Participant which corresponds to the appropriate layer and or branch within the model. The layer defining module defines participants to the appropriate layer and or branch within the overall marketplace structure for example at the root, branch or leaf layers, taking parent-child relationships into account.

In an example embodiment, the Revenue Sharing Server may include a verification module and a sharing module and or other modules. The verification module may be configured to verify the identity of the following: a Lister that lists the good that is sold, a Seller that Sells the corresponding good, and the Parent of the Seller. The sharing module may be configured to distribute sales revenue including fee revenue according to the model's method between the Seller, the Parent of the Seller, and the Lister.

In an example embodiment, sub-layers may be classified into a higher layer and a lower layer, or Parent and Child according to the contract and model structure.

In an example embodiment, the root layer may provide a new upper branch node with a Platform according to the contract between the root and corresponding branch and in keeping with the model structure.

Branches may provide a Platform to a new leaf node according to the contract and in keeping with the model structure.

In an example embodiment of the present invention, in the event that a new leaf participant forms within the model, the leaf's Parent site becomes a branch site, unless the new leaf is directly attached to the root site.

In an example embodiment of the present invention, the online market management system may further include an expected revenue calculation Server configured to calculate revenue to distribute between the Seller, the Parent of the Seller, and the Lister (if the Lister is a separate node).

In an example embodiment of the present invention regarding the method, a branch Seller who has an inventory of goods and who does not act as the direct seller due to the use of a Listing site may be able to obtain revenue of F×(r×α+γ)×N×P (wherein, ‘F’ is the fee per good, ‘r’ is the number of child branches extended from one branch, ‘α’ is the revenue sharing ratio for a recruiting activity, and ‘γ’ is the revenue sharing ratio for a Listing activity, ‘N’ is the total number of sites, P=1/N2, and ‘P’ is the revenue sharing probability). This is by definition the Seller's expected revenue based on mathematical probability. Variables within the model including the revenue sharing ratio for recruiting activity and the revenue sharing ratio for Listing activity are by definition flexible or variable in nature rather than fixed. Within an example embodiment of the present invention, N may vary depending on the structure present at the time of the calculation.

For the remainder of this document, the “×” multiplication sign will be omitted and multiplication within formulae will be implied when two or more variables are adjacent to each other, which is consistent with standard algebraic notation.

In an example embodiment, a branch seller who does not have an inventory of goods and who does not act as the direct seller due to the use of a Listing site may be able to obtain revenue of F(rα+β)NP (wherein, ‘F’ is a fee per good, ‘r’ is the number of child branches extended from one branch, ‘α’ is the revenue sharing ratio for a recruiting activity, ‘β’ is the revenue sharing ratio according to a sales transaction activity, ‘N’ is the total number of sites, P=1/N2, and ‘P’ is the revenue sharing probability). This is by definition the Seller's expected revenue based on mathematical probability. Variables within the model including the revenue sharing ratio for recruiting activity and the revenue sharing ratio for sales transaction activity are by definition flexible or variable in nature rather than fixed. N may vary depending on the structure present at the time of the calculation.

The expected revenue ratio of a root, a branch and a leaf may be defined as rα+1:(r−1)α+1:1−α (wherein, ‘r’ is the number of child branches extended from one branch, and ‘α’ is revenue sharing ratio for a recruiting activity), and ‘α’ is a variable used to control the revenue ratio between the branch and leaf within an example embodiment.

A new “Freeconomics” Business model is realized by an example embodiment of the present invention, related to the method for managing the fee revenue sharing of the Multi-Layer and Multi-Branch growth model with clearly defined nodes which act as Sellers, Parents of a Seller, and Listers, and which encourages an increase in sales transaction-related traffic due to a network effect. This model allows investment in the online brand to be minimized while also acting to increase the size of the network.

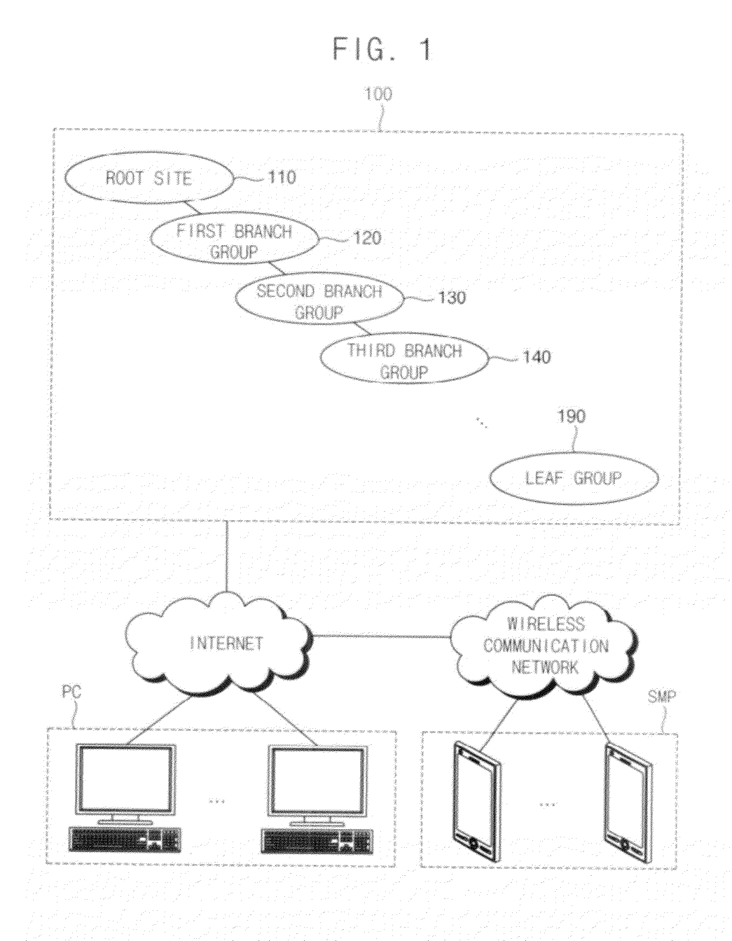

In an example embodiment of the present invention, FIG. 1 is a diagram which outlines a summary structure of the online marketplace system, the Internet and a wireless network.

Referring to FIG. 1, this online market management system which is an example embodiment of the present invention, may include a root site 110, a plurality of branch groups 120, 130 and 140 and a leaf group 190. In the present example embodiment, the root site 110 may be referred to as the Internet site. The Internet site may be a wired Internet site or a wireless Internet site. Moreover, the branch groups 120, 130 and 140 or the leaf group 190 may be an aggregate of Internet sites. The online market built by the online market management system of the present invention may be connected to a computer capable of accessing Internet and so on. Alternatively, the online market may be connected to a smart phone SMP having a calling function and Internet accessing function.

The root site 110 may correspond to a first layer of the online market within an example embodiment. According to the present example embodiment, the root site 110 may develop a Platform for realizing an online market, and may provide a developed Platform with the branch groups 120, 130 and 140, the leaf group 190, etc., through a predetermined contract. In the present example embodiment, the Platform may be delivery contents, a service, an application, etc., such as Facebook, Google maps, Apple iTunes. For example, the Platform may be a location based Services (“LBS”) Platform, an E-commerce Platform, a Messaging Platform, Contents Distributing Platform, a Social Network Service (“SNS”) Platform, a Business to Business (“B2B”) Platform, a Common Platform, etc.

In an example embodiment of the present invention, the branch groups 120, 130 and 140 may include, for example, a first branch group 120, a second branch group 130, a third branch group 140, etc. In the present example embodiment, the first branch group 120 may include multiple Internet sites corresponding to a second layer of the online market, the second branch group 130 may include multiple Internet sites corresponding to a third layer of the online market, and the third branch group 140 may include multiple Internet sites corresponding to a fourth layer of the online market. A predetermined Internet site belonging to the second layer is dependent to a predetermined Internet site belonging to the first layer, and a predetermined Internet site belonging to the third layer is dependent to a predetermined Internet site belonging to the second layer. A predetermined Internet site belonging to the fourth layer is dependent to a predetermined Internet site belonging to the third layer. That is, Internet sites belonging to the same layer may be in a horizontal relationship, and Internet sites belonging to the different layers may be in a vertical relationship.

The leaf group 190 may be an Internet site corresponding to an n-th layer of the online market. Multiple leaf Internet sites may be exist within the leaf group 190. Each leaf Internet site is dependently connected to one of Internet sites of a bottom layer belonging to the branch group.

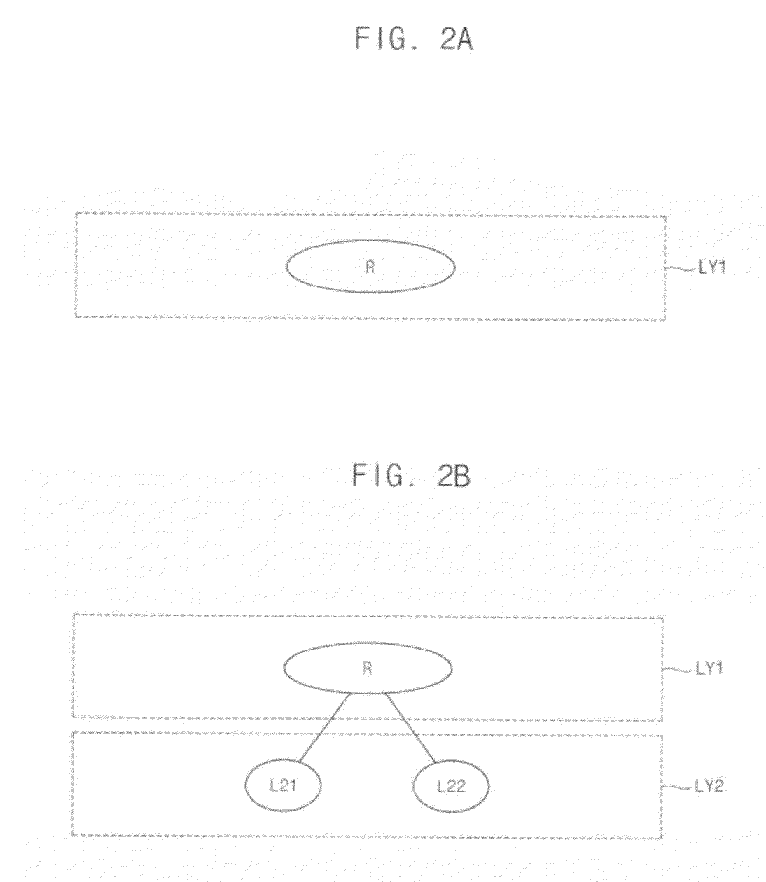

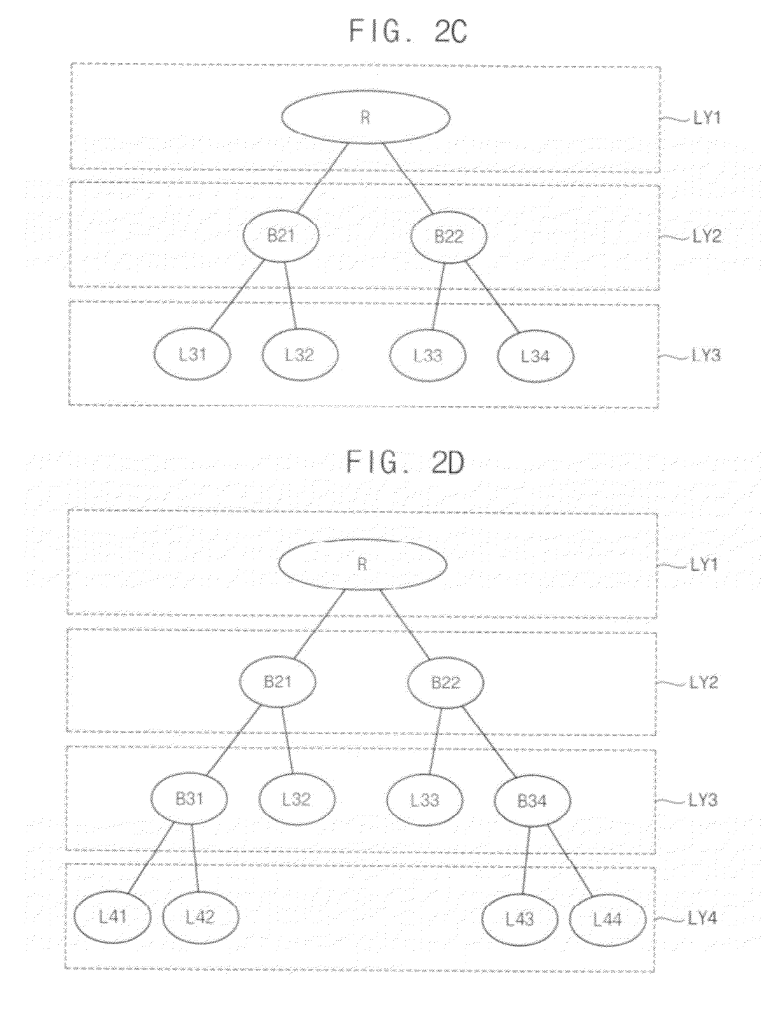

In an example embodiment of the present invention, FIGS. 2A to 2D are schematic diagrams explaining a process of a multi-layer and multi-branch growth model by the online market management system of FIG. 1. In FIGS. 2A to 2D, a root site, a branch site and a leaf site are represented by reference numerals “R,” “B” and “L,” respectively.

Referring to FIG. 2A, the root site R develops a Platform for realizing the online market, and plays a role of distributing the developed Platform. Thus, the root site R belongs to a first layer LY1 of the online market. As the developed Platform is distributed, it will become available for posting or selling activities by a user.

Referring to FIG. 2B, when the root site R receives a request from a potential Seller or Lister who would use a corresponding Platform, the root site R completes a contract with a corresponding requestor. Upon contract completion the requestor is mapped as a leaf participant to receive a Platform.

For example, a first requestor is mapped as a first leaf node or business L21, and a second requestor is mapped as a second leaf node or business L22. The first and second leaf businesses L21 and L22 may obtain the second layer LY2 position within the online market. The first and second leaf businesses L21 and L22 may post a good on a Platform provided from a root site R, and may share profits (hereinafter, referred to as revenue) which are generated in accordance with a sale of the goods with the root site R. The first and second leaf businesses L21 and L22 may recruit requestors who are willing to post and sell goods which in the process acts to increase marketplace activity.

Referring to FIG. 2C, when the first and second leaf businesses L21 and L22 recruit requestors who are willing to post and sell goods by using a Platform, each of the first and second leaf businesses L21 and L22 complete contracts with the corresponding requestors. As the contract is completed, each of the first and second leaf nodes or businesses L21 and L22 become branches as they are now parents in the parent-child relationship of the model. The first leaf business L21 is mapped as a first branch business B21, and the second leaf business L22 is mapped as a second branch business B22.

For example, a third requestor and a fourth requestor completing a contract with the first leaf business L21 would obtain a third layer LY3 position within the online market. The third requestor is mapped as a first leaf business L31, and the fourth requestor is mapped as a second leaf business L32.

Upon contract completion with the second leaf business a fifth requestor and a sixth requestor L22 would obtain a third layer LY3 position within the online market. The fifth requestor is mapped as a third leaf business L33, and the sixth requestor is mapped as a fourth leaf business L34.

The first to fourth leaf businesses L31, L32, L33 and L34 have the ability and permissions necessary in order to post goods on a Platform, and sell goods posted by the root node, another branch node, or another leaf node. As goods are sold, revenue from the sale may be shared with other nodes or businesses. The distribution of revenue among the participants will be described below. The first to fourth leaf businesses L31, L32, L33 and L34 may recruit requestors who are willing to post and sell goods and in this process marketplace activity may increase.

Referring to FIG. 2D, when the first and fourth leaf businesses L31 and L34 belonged to a third layer LY3 recruit requestors who are willing to post and sell goods by using a Platform, each of the first and fourth leaf businesses L31 and L34 may complete contracts with corresponding requestors and in the process become parent sites.

As a corresponding contract is completed, each of the first and fourth leaf businesses L31 and L34 becomes a branch node or business. That is, the first leaf business L31 is mapped as a third branch business B31, and the fourth leaf business L34 is mapped as a fourth branch business B34. A second leaf business L32 and a third leaf business L33 who do not recruit requestors willing to post and sell goods are not raised to be maintained as a leaf business. Nodes B31 and B34 become parents while nodes L32 and L33 remain child sites at this point.

For example, a seventh requestor and an eighth requestor completing a contract with a third branch business B31 would obtain a fourth layer LY4 position within the online market. The seventh requestor is mapped as a first leaf business L41 in the multi-layer and multi-branch growth model, and the eighth requestor is mapped as a second leaf business L42. A ninth requestor and a tenth requestor completing a contract with a fourth branch business B34 would obtain a fourth layer LY4 position within the online market. The ninth requestor is mapped as a third leaf business L43 and the tenth requestor is mapped as a fourth leaf business L44 within the structure of the model.

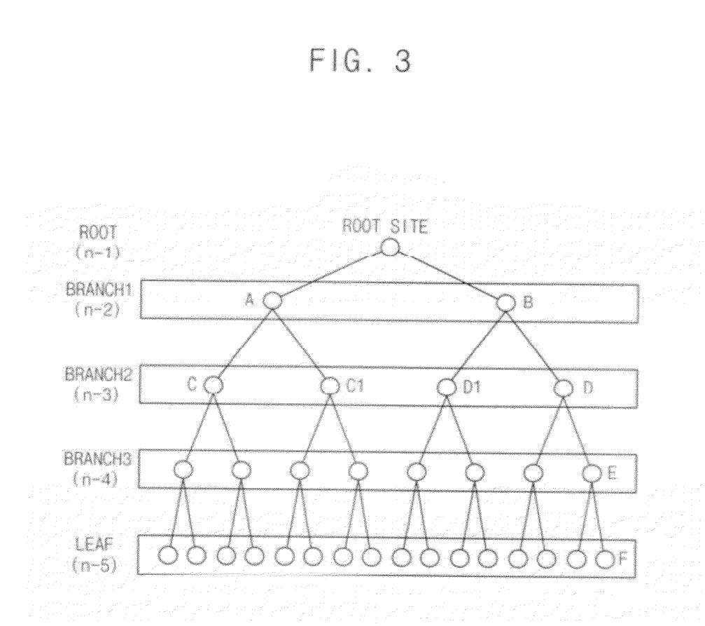

In an example embodiment of the present invention, FIG. 3 is a schematic diagram illustrating the overall structure of the multi-layer and multi-branch growth model including detailed layers and nodes. Hereinafter, the abbreviation “(n,r)-ary” shall refer to an example embodiment of the present invention with regard to a Multi-Layer and Multi-Branch Growth model. FIG. 3 shows an (n,r)-ary model which has n=5 layers and r=2 branches.

Referring to FIG. 3, the root site owner within the first layer may complete contracts with sellers “A” and “B” who are owners of branch node sites, and provide a Platform or online sub-marketplace site to sellers A and B.

Seller “A” may recruit and complete contracts with seller “C” who is one Internet site owner and seller “C1” who is another Internet site owner, and then provide both seller “C” and seller “C1” with Platforms or online sub-marketplace sites. Seller “B” may recruit and complete contracts with seller “D” who is one Internet site owner and seller “D1” who is another Internet site owner, and then provide both seller “D” and seller “D1” with Platforms or online sub-marketplace sites.

The layer distribution and propagation process described above may be further continued to a leaf seller that is the last or bottom layer. Child sites may continually join the model structure through a contract with another site, which may already be a parent, or which may become a parent site through the joining process.

In the (n,r)-ary model (wherein, ‘n’ is the number of layers, and ‘r’ is the number of child branches extended from one branch), revenue generated in accordance with Recruiting, Selling and Listing activities may be allocated to participants.

For example, in FIG. 3, it is assumed that seller “E” sells a good Listed by the seller “C,” sellers “C,” “E” and “D” would share revenue along with “C” according to the sale of the good. That is, the seller “C” receives revenue for Listing or posting the good, the seller “E” receives revenue for Selling the good, and “D” receives revenue for a recruiting a good seller or put another way, for being the parent of “E”. Likewise, Seller “C” would receive revenue even if the good is not sold by the seller “C.” “E” receives revenue even if the good is out of stock by fulfilling the sale through the use of a third party fulfillment agent. Furthermore, Lister site “D” who is not directly related to the good Listing or selling would earn revenue by recruiting site “E,” or being its parent.

In this case, the site “D” receives revenue due to recruiting activity; however, site “B” and the root site owner are excluded from revenue sharing. Thus, revenue is shared with a Listing or posting participant, a selling participant and a recruiting participant who are directly related to the goods selling, so that the posting participant, the selling participant and the recruiting participant.

Hereinafter, revenue according to the (n,r)-ary model will be described in detail. For convenience of description, it is assumed that within the (n,r)-ary model goods are Listed or posted on a Platform or sub-marketplace site. That is, r branches within one layer are distributed in n layers, so that the number ‘N’ of participants is be defined as follows in Equation 1:

$$N = \frac{{r}^{n} - 1}{r - 1} \qquad Equation 1$$

Here, ‘N’ is the number of participants within the example online market, ‘r’ is the number of branches, and ‘n’ is the number of layers.

When the main Selling agent is determined, a main recruiting agent is automatically determined so that the number of total cases is N². Thus, a probability P of sharing revenue in accordance with listing, selling and recruiting activities with participants for one good is defined as follows in Equation 2:

$$P = \frac{1}{{N}^{2}} \qquad Equation 2$$

Here, ‘P’ is the revenue sharing probability.

When one good is sold, the number of revenue generating cases which are based on listing, selling and recruiting activities vary depending on the position of the participant (or the layer of the participant) as follows in Table 1.

TABLE 1

| | Recruiting | Selling | Posting |
|---|---|---|---|
| root | (r + 1)N | N | N |
| r-branch | rN | N | N |
| r-leaf | 0 | N | N |

Referring to Table 1, it may be easily understood that the number of revenue generating cases varies depending on the marketplace position or layer of the participant.

In a case of a leaf, which is by definition exists at the bottom layer, the number of revenue generation cases from recruiting activity is zero since a lower layer does not exist.

In a case of r-branches present, r children (or Internet sites corresponding to r lower layers) exist. Thus, the number of cases where one child sells a good is N, so that the number of revenue generation cases is rN.

The root site, which by definition exists at the uppermost layer, has (r+1)N number of revenue generation cases, since the root site is able to sell directly by itself in addition to the number of revenue generation cases of rN for r branches, representing the branches that the root has in this example.

In an example embodiment of the present invention, a (n,r)-ary model may provide Sellers with superior selling opportunities compared to a conventional marketplace. In order to explain the above, revenue for a good is defined as F, and the revenue sharing ratio for Recruiting, Selling and Listing activities is defined as α, β and γ, respectively. In this case, α+β+γ=1.

When one good is sold, the participant of each layer has expected revenue which equals the summation of expected revenue generated by Recruiting, Selling and Listing activities. Thus, the expected revenues of the root, r-branch and r-leaf are represented in Table 2 as follows:

TABLE 2

| | Recruiting | Selling | Listing |
|---|---|---|---|
| root | F(r + 1)αNP | FβNP | FγNP |
| | (rα + 1)FNP > FNP | | |
| r-branch | FrαNP | FβNP | FγNP |
| | ((r − 1)α + 1)FNP > FNP | | |
| r-leaf | 0 | FβNP | FγNP |

(1 − α)FNP < FNP

In an example embodiment of the present invention, the Multi-Layer and Multi-Branch Growth model may provide Sellers with superior selling opportunities when compared to a conventional single-layer marketplace because Listers may provide the Seller with additional Platforms or sites from which to display goods and the Seller then compensates the Lister for this additional Selling Platform. In a single-layer marketplace, a host site is dependent on and connected to multiple sellers horizontally.

In the case of a seller with r branches who has an inventory of goods and who does not act in the selling capacity, no revenue is generated in a conventional platform. However, within an example embodiment of the present invention with regard to a Multi-Branch and Multi-Layer Growth model, a seller with r branches who has an inventory of goods and who Sells through a separate Lister, would receive expected revenue per Equation 3 as follows:

F(rα+γ)NP Equation 3

That is, within an example embodiment of the present invention with regard to a Multi-Branch and Multi-Layer Growth model, although the r-branch seller does not act as the Seller, the r-branch seller expects to receive recruiting revenue of Frα and posting revenue of FγNP.

Here, ‘F’ is a fee per good, ‘α’ is the revenue sharing ratio for recruiting activity, and ‘γ’ is the revenue sharing ratio for Listing activity.

In an example embodiment of the present invention with regard to a Multi-Branch and Multi-Layer Growth model, in a case of an r-branch seller who does not have an inventory of the goods and who acts as the Seller, the r-branch seller receives expected revenue through the use of a fulfillment third party per Equation 4 as follows:

F(rα+β)NP Equation 4

Here, ‘β’ is the revenue sharing ratio for the Selling activity.

In a conventional single-layer platform structure in which a posting participant posts and sells a good, expected revenue from listing or recruiting activity is zero because no cross-posting occurs and there are no Listers which exist to provide additional sales beyond what would occur on the Seller's platform or site. That is, with a single-layer marketplace structure, the key relationship is between the root site and leaf sites, so that the leaf sites share revenue with the root site unilaterally. When one good is sold in a horizontal structure, expected revenue is F. When a root site and a leaf site share revenue F in a ratio of α:β, expected revenue for the root site is F×α, and expected revenue of the leaf site is F×β×N×P where ‘N’ is the total number of sites, and P=1/N².

On the other hand, within an example embodiment of the present invention with regard to a Multi-Branch and Multi-Layer Growth model, expected revenue greater than FNP is likely to be generated to the root and the branch participants that are also parents. The leaf participant has expected revenue of F·(1−α)·N·P.

Thus, in an example embodiment of the present invention with regard to a Multi-Branch and Multi-Layer Growth model, most participants are financially incented to List goods and or to move to a higher layer and become parents.

For the specific sharing ratio ‘α’ corresponding to recruiting activity, expected revenues of participants may be calculated. Therefore the marketplace has built-in flexibility with regard to a given sharing ratio. In Table 2 above, when the expected revenue ratio of the root, an r-branch and an r-leaf is calculated, the result is defined in Equation 5 as follows:

rα+1:(r−1)α+1:1−α Equation 5

In other words, setting the variable ‘α’ (the sharing ratio for recruiting activity) determines the revenue ratio between an r-branch and an r-leaf. In addition competition between sellers due to a seller not having a large inventory of goods is managed by setting the revenue sharing ratio ‘β’ (the sharing ratio for selling activity.)

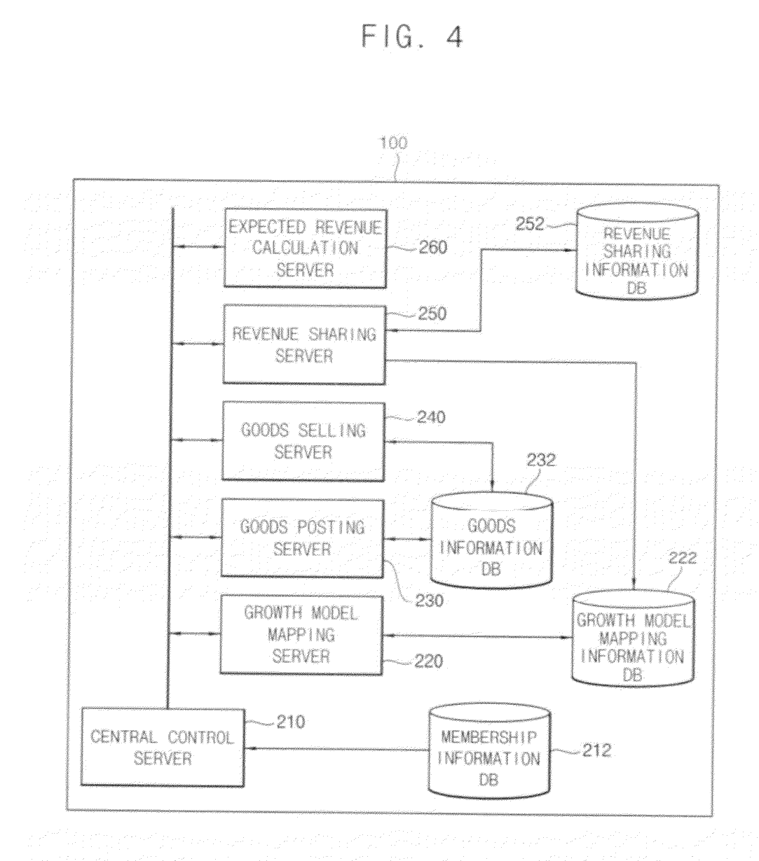

FIG. 4 is a block diagram showing root site 110 of FIG. 1.

In an example embodiment of the present invention, referring to FIGS. 1 to 4, a root site 110 according to the present example embodiment includes a Central Control Server 210, a Role Mapping Server 220, a Goods Posting Server 230, a Goods Selling Server 240, a Revenue Sharing Server 250 and an Expected Revenue Calculation Server 260. In the present example embodiment, the Central Control Server 210, the Role Mapping Server 220, the Goods Posting Server 230, the Goods Selling Server 240, the Revenue Sharing Server 250 and the Expected Revenue Calculation Server 260 are described separately in logical terms using software terminology for ease of understanding, and are not described in terms of hardware terminology.

The central control Server 210 is dependently connected to a Platform business site, and is dependently connected to the Internet site of the first branch group. The root site 110 including the central control Server 210 is positioned at a higher layer Internet site than the first branch group 120. The central control Server 210 may be a Web Server. Alternatively, the central control Server 210 may be wireless application protocol (“WAP”) Server. In the present example embodiment, the central control Server 210 may play a Role as a central control tower which controls or manages the Role Mapping Server 220, the Goods Posting Server 230, the Goods Selling Server 240 and the Revenue Sharing Server 250.

As part of the process of a new participant computer or smart phone joining the Growth model structure, the Role Mapping Server 220 maps the user to the appropriate role mapping and stores these records in the Role Mapping Information Database DB 222.

When a good is sold, the Mapping stored within the Server and Database are used to determine the identity of the Seller, Parent of Seller (or Recruiter), and Lister within the model structure. In other words, when the good is sold and revenue is generated, the Mapping is used to determine who will receive part of the revenue (Seller, Parent of Seller, and Lister) within the model.

In an example embodiment of the present invention, a participant may be a web site manager managing an additional online marketplace or a web site manager who is willing to manage a new online market site.

When a participant requests to post a good on a Platform, the Goods Posting Server 230 posts the good on the Platform.

As a buyer purchases a good, the buyer's terminal is accessed via the Central Control Server 210, the Goods Selling Server 240 provides the terminal of a buyer with goods information stored in the Goods Information Database DB 232 via the Central Control Server 210. Once the buyer requests to purchase the good, the process of selling the good is performed, assuming a successful transaction.

When the corresponding good is sold, the Revenue Sharing Server 250 shares revenue generated in accordance with the selling of the good with the Listing participant who posted the good, the selling participant who sold the good, and the Parent of the Seller, (or Recruiting participant) who recruited the Seller. In addition, the Revenue Sharing Server 250 will store records pertaining to the sharing of revenue between the Seller, the Parent of the Seller, and the Lister within the Revenue Sharing Information Database DB 252.

The Expected Revenue Calculation Server 260 calculates expected revenue and provides this to the Seller, Parent of the Seller, and Lister relating to the sale of a good.

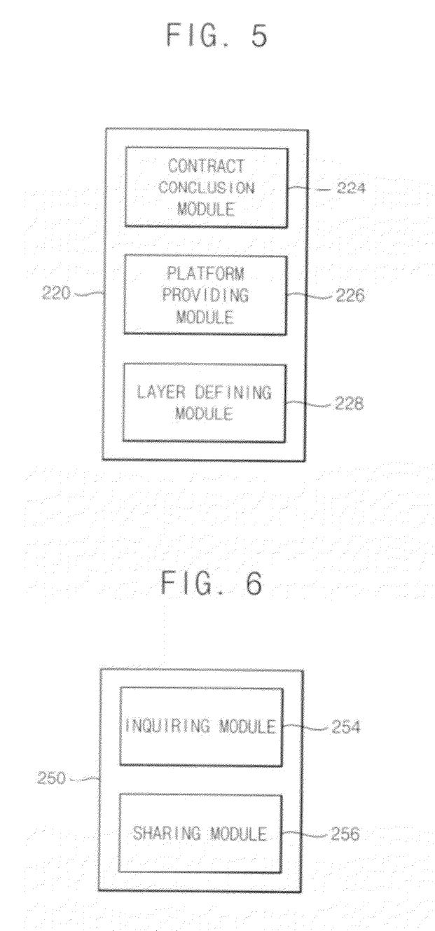

FIG. 5 is a block diagram showing the Role Mapping Server 220 of FIG. 4.

Referring to FIG. 5, the Role Mapping Server 220 includes a Contract Module 224, a Platform Providing Module 226 and a Layer Defining Module 228. The term “ . . . module”, within an example embodiment of the present invention with regards to a model means a unit which processes at least one function or operation. The term “module” may be realized as hardware, software, or a combination of hardware and software.

The Contract Module 224 facilitates the establishment of a contract between the root site business and a branch node or corresponding business. Additionally, the Contract Module 224 facilitates the establishment of contracts between a Parent site and the Parent's child, or a Recruiter and the corresponding Recruited site.

Upon successful contract completion, the Platform Providing Module 226 provides a new participant with a Platform which becomes part of a corresponding branch within the model.

Upon successful contract completion, the Layer Defining Module 228 assigns participants to the appropriate layer within the model structure. Factors determining the layer include whether the participant is directly below the root or below a branch participant of a defined layer. If the new participant is below what had been a leaf participant the leaf participant immediately becomes a branch participant as part of the process of the new participant joining the model structure.

FIG. 6 is a block diagram showing the Revenue Sharing Server of FIG. 4.

Referring to FIG. 6, the Revenue Sharing Server 250 includes an Inquiring Module 254 and a Sharing Module 256.

The Inquiring Module 254 verifies which participant has sold the corresponding good, which participant is the Parent (or Recruiter) of the Seller, and which participant is the Lister of the corresponding sold good. The Inquiring Module 254 verifies these identities based on the records stored in the Role Mapping Information Database DB 222.

In an example embodiment of the present invention, the Sharing Module 256 shares revenue from the sale of goods between the Seller, the Parent (or Recruiter) of the Seller, and the Lister according to the method for distribution of revenue in the Multi-Branch and Multi-Layer Growth model.

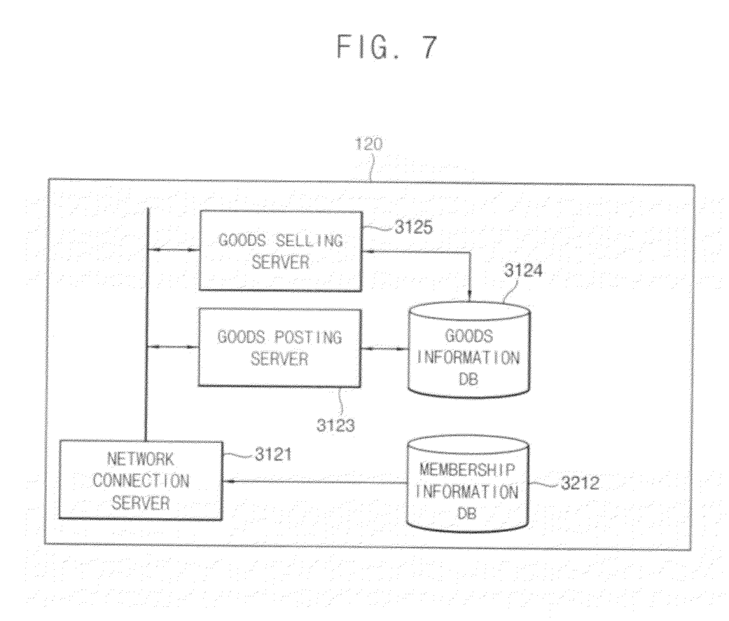

FIG. 7 is a block diagram illustrating an example of an Internet shopping mall within a first branch group 120 (or layer) of FIG. 1

FIGS. 1 through 7, illustrate a sample Internet shopping mall of branch group 120 and includes a Network Connection Server 3121, a Membership Information Database (DB) 3122, a Goods Posting Server 3123, a Goods Information DB 3124 and a Goods Selling Server 3125.

The network connection Server 3121 is dependently connected to the root site 110 (shown in FIG. 1), and is dependently connected to the second branch group (shown in FIG. 1). The Internet shopping mall, including the network connection Server 3121, is positioned at a lower layer than the root site 110, and is positioned above the second branch group. The network connection Server 3121 functions as a central control tower controlling the operation of the Goods Posting Server 3123 and the Goods Selling Server 3125.

The Membership Information Database DB 3122 stores membership information pertaining to the Internet shopping mall members. The membership information may include the ID of a member, a password corresponding to the ID, purchase history information of the member, etc.

The Goods Posting Server 3123 receives information regarding goods available for purchase via the Network Connection Server 3121 and may store goods information on the Goods Information Database DB 3124. Alternatively, the manager of the Internet shopping mall may provide the information regarding the goods available directly which may then be stored in the Goods Information Database DB 3124.

When a terminal (i.e., either a computer connected with a wired network connection that is connected thereto, or a Smartphone with a wireless network connection is connected thereto, etc.) of a buyer who is willing to purchase a good is accessed via the Network Connection Server 3121, the Goods Selling Server 3125 provides the terminal of a buyer with the information pertaining to the corresponding good from the Good Information Database DB 3124 via the Network Connection Server 3121. When a buyer requests to purchase a good, the process of selling the corresponding good may be performed.

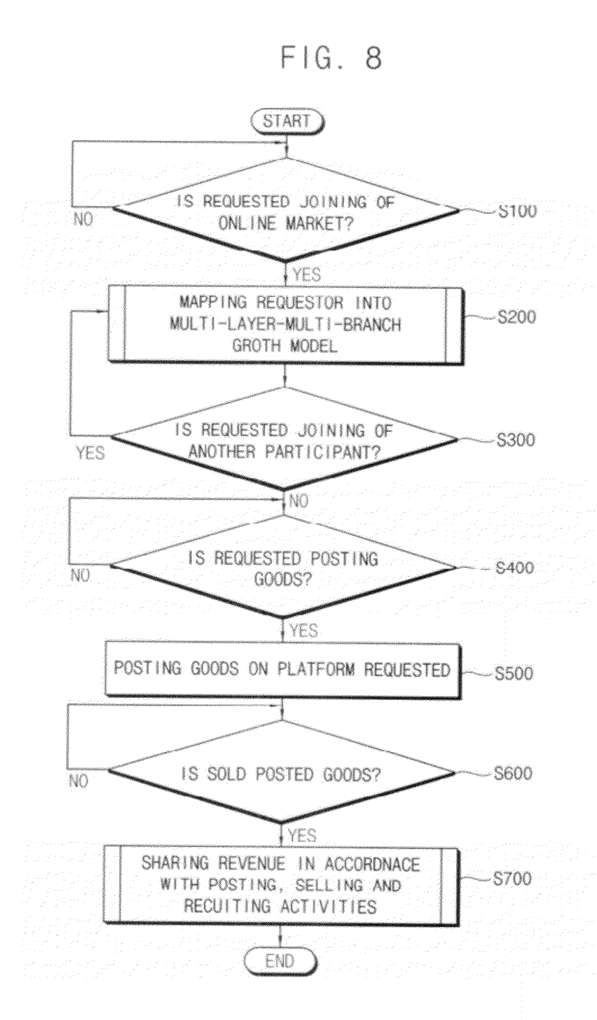

In an example embodiment of the present invention, FIG. 8 is a flow chart which shows how many aspects of the marketplace are managed, including a user joining the marketplace, the user being mapped with the appropriate role and hierarchical position within the structure, the Selling of goods, the Listing of goods and the distribution of revenues.

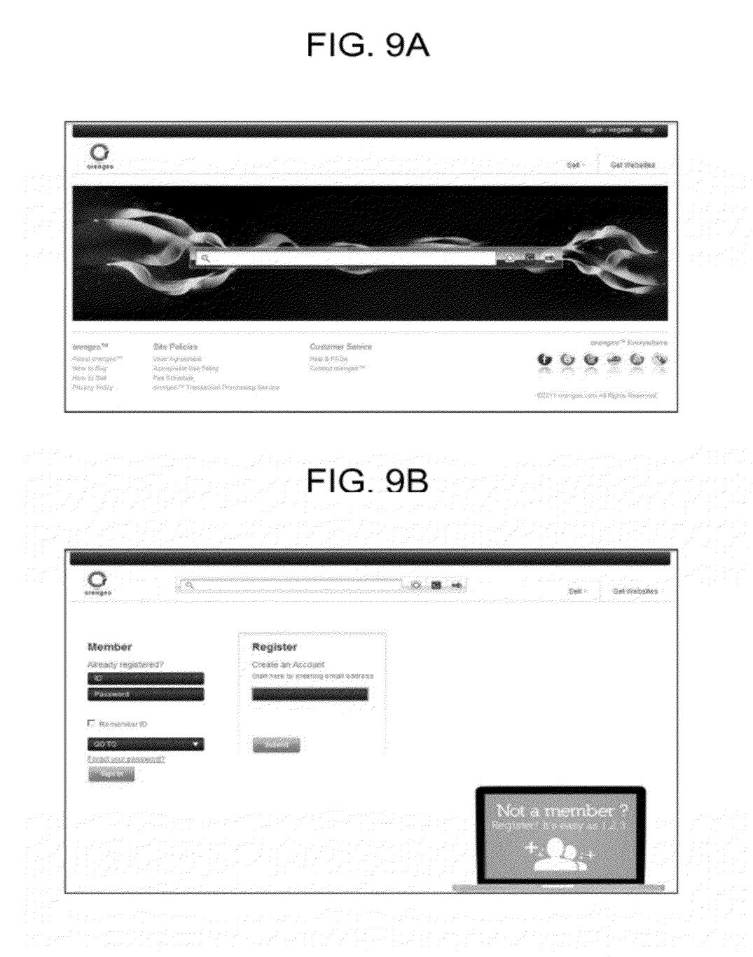

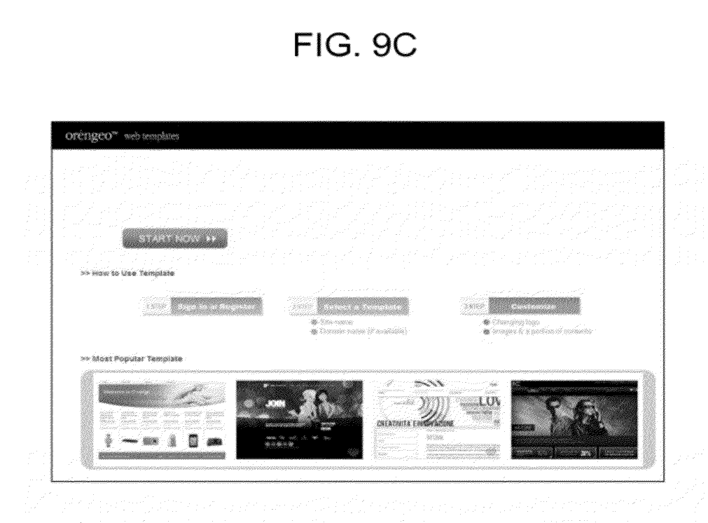

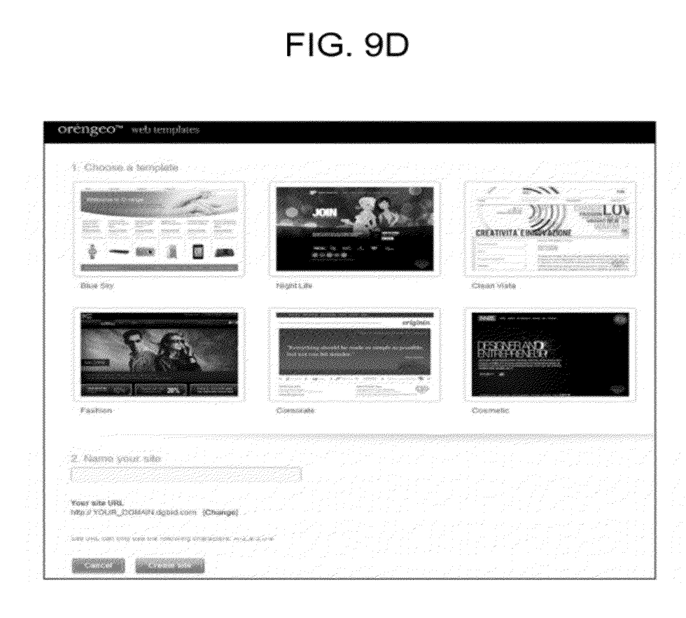

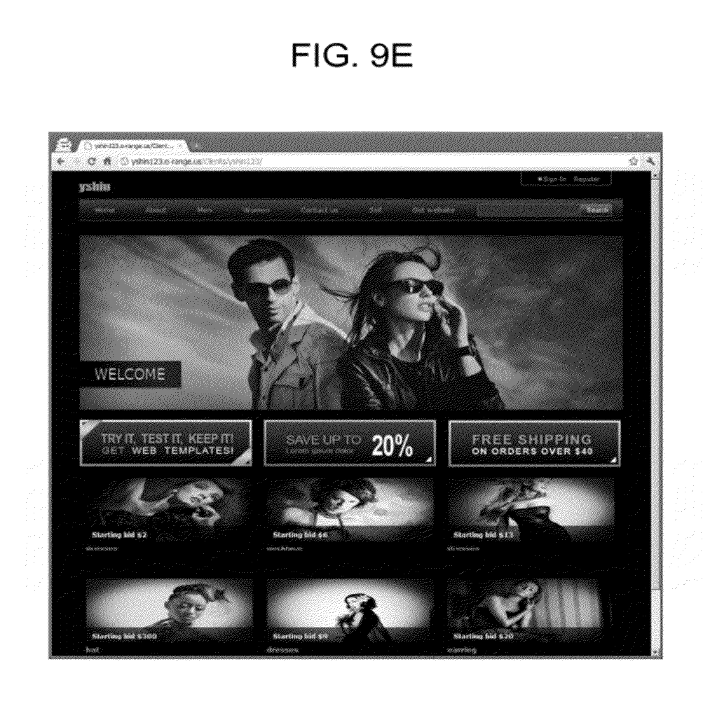

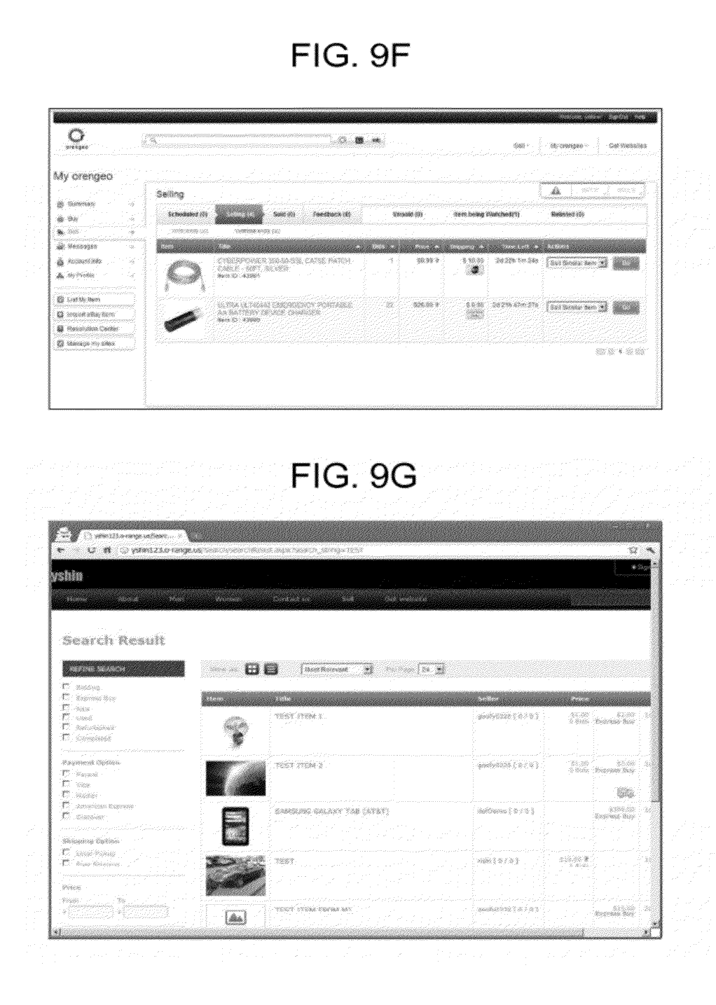

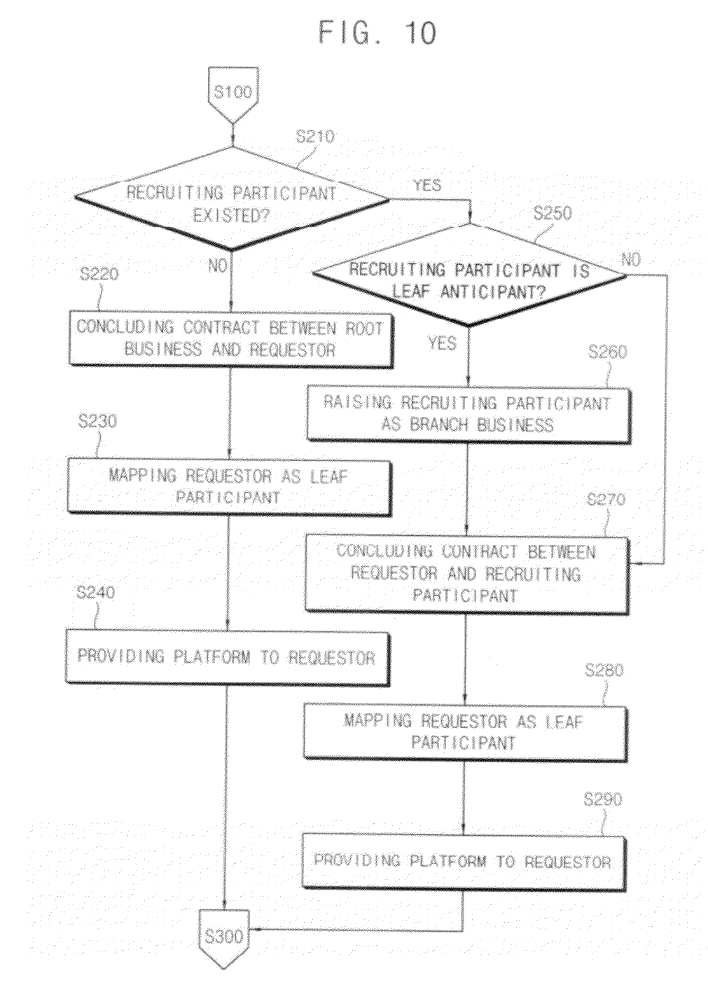

FIG. 9A is an image of a graphical user interface (hereinafter referred to as “GUI”) within an example main webpage of a root site. FIG. 9B is an image of a sample webpage GUI used for joining and logging in to the system. Referring to FIG. 9B, a page for joining or logging in may include windows for inputting the ID of the member and the password which corresponds to the ID, and window for a new member to use in order to join. If a user clicks the window for member joining a request to join the online market is made.

When a request to join the online market is made in step S100, the corresponding requestor is mapped as a participant (step S200). FIG. 9C is an image of a sample GUI webpage for a site wizard available to new users in order to establish a new site or sub-marketplace platform. Referring to FIG. 9C, in order to receive a desired web template, when the user clicks the “START NOW” button, a webpage such as FIG. 9D is then displayed.

FIG. 9D is an image of a sample GUI webpage for selecting and naming web templates as an example sub-marketplace platform. In FIG. 9D, when the user clicks a desired web template and enters the URL of the Internet site which is operated by the user, a webpage such as FIG. 9E is displayed.

FIG. 9E is an image of a sample user's GUI webpage which provides an example of a new site or sub-marketplace platform. Referring to FIG. 9E, a background image of a web template, and various categories of goods that are available for sale such as dresses, necklaces, hats, etc., are displayed on a new site screen.

The Multi-Layer and Multi-Branch Growth model may be classified into a root belonging to a first layer, a leaf belonging to a bottom layer, and a branch belonging to an intermediate layer which is between the root and the leaf. The structure of the Multi-Layer and Multi-Branch Growth model is described in FIGS. 2A to 2D and 3, and thus any repetitive detailed explanation will hereinafter be omitted. In step S200, a new leaf business site may be generated, and a domain name may be allocated to the new leaf business site.

Pseudo-code corresponding to the generation of the new leaf site is illustrated as follows:

======================================================
===================================
Initialize current login data
Get current site data
Set new site data's template ID to selected template ID
Get sub-domain name
If sub-domain doesn't exist

Get selected template's physical location

Copy template contents to sub-domain folder
For each set of template contents

Copy personalization information to sub-domain's content
Register sub-domain to local Domain Name Server (DNS) and
application Server
Set parent site ID to current site ID
Create Roles (buyer, seller, and site owner) for the new site
Register current user as site owner

Else

Prompt: site exists

======================================================
===================================

Moreover, a pseudo-code corresponding to an allocated domain name to the new leaf site is illustrated as follows:

======================================================
===================================
Get http request Uniform Resource Locator (URL) header
Find matched site for the header
Get client URL for the matched site
Redirect request to client URL
======================================================
===================================

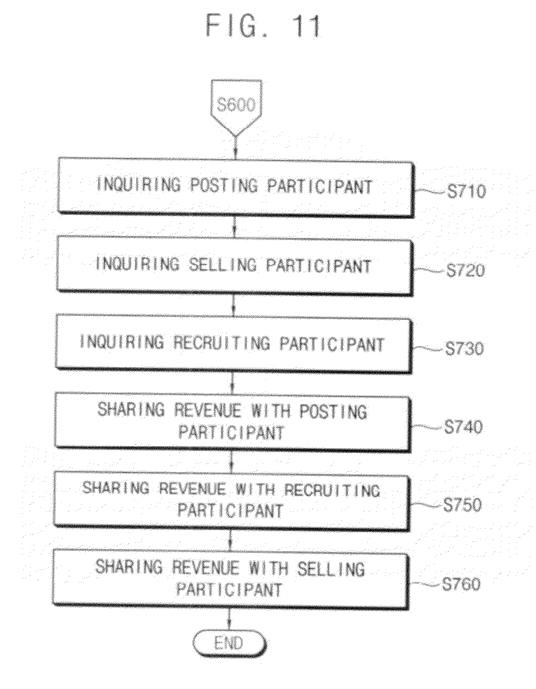

A detailed description of step S200 will be described in FIG. 10 below.

The next step verifies whether or not the new participant who is joining the market is doing so as a request underneath another participant, who would become the parent in that relationship (step S300).

After the system verifies (within step S300) whether or not the new participant who is joining the online market as a request underneath another participant, it returns to step S200.

In step S300 it is determined that the new participant is not joining the market through another participant, the system verifies whether or not the new participant is requesting the posting of goods on a predetermined Platform (step S400).

If the new participant is requesting to post a good on the predetermined Platform, the good is then posted on the predetermined Platform (step S500). Pseudo-code corresponding to posting of a good on the predetermined Platform is illustrated as follows:

======================================================
===================================
(Gets the sales draft by draft ID)
Get current site information
Get current user information
Initialize sales data
Set sales type (auction, retail, etc.)
Set listing site ID for the sales data to current site ID
Set Seller ID to current user ID
(Save the sales draft with draft ID)
(Preview the sales)
If current user is not the Seller

Register the user as Seller

Add the sales.
======================================================
===================================

FIG. 9F is an image of a sample Seller's GUI webpage for selling goods and is an example of a marketplace or sub-marketplace platform. Referring to FIG. 9F, goods information such as item, title, bids, prices, etc., are displayed on the goods selling page.

Pseudo-code corresponding to a purchase is illustrated as follows:

======================================================
===================================
Get sales item by sales ID
Get current site and user (buyer) information
Initialize purchase data
Set sold site ID for purchase data to current site ID
Set seller ID to seller ID for sales data
Add the purchase.
======================================================
===================================

Next, the system verifies whether or not the posted good is sold (step S600). In step S600, the selling of goods may be performed through various purchase paths. For example, the goods selling may be performed at an Internet site managed by a Seller participant who has posted the goods on the site that the seller owns. Alternatively, Selling may occur at a Lister's site which acts as an Internet site which is cross-posted to another goods posting site, such as the Seller's site for example.

FIG. 9G is an image of a sample Lister's cross-posting GUI webpage and is an example of a marketplace or sub-marketplace platform. Referring to FIG. 9G, a good posted in one site is also displayed in another site and may be available to be purchased at or from either site.

In step S600, after the system verifies that the posted good is sold, a payment for that sold good is paid, and revenue in accordance with Listing, selling and recruiting activities of the corresponding good is shared (step S700). Pseudo-code corresponding to the payment for the sold good is illustrated as follows:

======================================================
===================================
Get purchase information
Get current site and user (buyer) information
Initialize transaction data
Add payment processing fee item under transaction
Get shipping address
Add sales tax under the transaction
Add item cost to seller (sales−>seller ID)
Add sales commission to Listing site owner (sales −> site ID, listing
site −> owner ID)
Add sales commission to Sold site owner (purchase −> site ID, sold
site −> owner ID)
Add sales commission to Sold site Parent owner (sold site −> parent
site −> owner ID)
Add the transaction with transaction items, payment, and shipping
information.
======================================================
===================================

Pseudo-code corresponding to revenue sharing according to Listing, Selling and Recruiting activities of corresponding goods is illustrated as follows:

======================================================
===================================
Get active transactions
For each transaction in active transactions

If item is shipped but not paid item cost to seller

If shipping grace period has been past

Pay to seller
Set paid to seller date to today
Send message to seller that the item has been paid

Else if feedback from buyer has been made

If feedback grace period has past

Pay to seller
Set paid to seller date to today
Send message to seller that the item has been paid

Else if paid to seller and not released commission to site owners and
today is the month-end date

If paid to seller date is less than 15th of the month or is previous
month

Release commissions to owners

(Listing site's, Sold site's, and Sold site Parent's owners)
Close Transaction
======================================================
===================================

A detailed description of step S700 will be described in FIG. 11 below.

FIG. 10 is a flow chart which shows the Mapping functions of the multi-layer and multi-branch growth model as pictured in FIG. 8; and

Referring to FIGS. 8 and 10, the system verifies whether or not a new requestor joining the market has a Parent or corresponding Recruiting participant (step S210). The Parent, or Recruiting participant may correspond with a branch node or leaf node. The step S210 may be performed by the Role Mapping Server 220 (shown in FIG. 4).

In step S210, if a Parent or Recruiting participant does not exist, a contract between the root and the new requestor is completed (step S220). Step S220 is performed by the Contract Conclusion Module 224 (shown in FIG. 5).

Next, the new requestor is mapped as a leaf participant (step S230). In this case, the corresponding requestor may belong to a second layer. Step S230 is performed by the Layer Defining Module 228 (shown in FIG. 5).

Next, the system provides the new requestor with a Platform (step S240), and then returns to step S300. Step S240 is performed by the Platform Providing Module 226 (shown in FIG. 5).

In step S210, if the system determines that a Parent or Recruiting participant exists, the system then verifies whether or not Parent or Recruiting participant is a leaf participant or leaf node (step S250). Step S250 is performed by the Role Mapping Server 220 (shown in FIG. 4).

In step S250, if the system determines that the Parent or Recruiting participant is a leaf node, Parent or Recruiting site is promoted to a branch node (step S260). Step S260 is performed by the Role Mapping Server 220 (shown in FIG. 4).

Then, a contract between the root site business and the new requestor is completed (step S270). Step S270 is performed by the Contract Conclusion Module 224 (shown in FIG. 5).

Then, the requestor is mapped as a leaf participant (step S280). Step S280 is performed by the Layer Defining Module 228 (shown in FIG. 5).

Then, the system provides the new requestor with a Platform (step S290), and then returns to step S300. Step S290 is performed by the Platform Providing Module 226 (shown in FIG. 5).

Within an example embodiment of the present invention, FIG. 11 is a flow chart illustrating the revenue sharing functions which correspond to the Listing, Selling and Recruiting activities as pictured in FIG. 8

Referring to FIGS. 8 and 11, a posting participant who posts the sold good is inquired (step S710). The inquiring module 254 (shown in FIG. 6) may inquire a Role Mapping information stored in the Role Mapping Information Database DB 222 (shown in FIG. 4), so that the step S710 may be performed.

Next, the system verifies the Selling participant who is selling a good (step S720). In order to perform this step (step S720), the Inquiring Module 254 may use Role Mapping information stored in the Role Mapping Information Database DB 222.

Next, the system verifies whether or not the Selling site has a Parent, or Recruiting participant (step S730). In order to perform this step (step S730), the Inquiring Module 254 may use Role Mapping information stored in the Role Mapping Information Database DB 222.

Then, revenue fees corresponding to the goods Listing is shared with the Listing site (step S740). Step S740 is performed by the Sharing Module 256 (shown in FIG. 6).

Then, revenue fees corresponding with the selling of the goods is shared with the Seller (step S750). Step S750 is performed by the Sharing Module 256 (shown in FIG. 6).

Then, revenue fees corresponding to the Recruiting aspect is shared with the Parent or Recruiting site (step S760). Step S760 is performed by the Sharing Module 256 (shown in FIG. 6). In step S730, if a Parent or Recruiting participant who corresponds with the Selling participant does not exist, step S760 is omitted.

In an example embodiment of the present invention, steps S710, S720 and S730 are described as being performed sequentially; however, the sequence of steps may change. Moreover, steps S710, S720 and S730 may be performed simultaneously.

In an example embodiment of the present invention, steps S740, S750 and S760 are described as being performed sequentially; however, the sequence of steps may change. Moreover, steps S740, S750 and S760 may be performed simultaneously.

A new “Freeconomics” Business model is realized by an example embodiment of the present invention with regard to a method for managing the fee revenue sharing of the Multi-Layer and Multi-Branch Growth model with clearly defined nodes which act as Sellers, Parents of a Seller, and Listers, and which encourages an increase in sales transaction-related traffic due to a network effect. This model allows investment in the online brand to be minimized while also acting to increase the size of the network.

Moreover, according to the present invention, creating revenue by distributed participants is different from marketing by SNS, and sharing revenue with Recruiting, Selling and Listing activities is different from multi-level marketing or pyramid selling. Therefore, new entrants to the online market without brand value may grow rapidly.

In an example embodiment of the present invention, the process may be carried out in a fee discounting and or a market-friendly manner in order to share revenue with participants, and may be used in a mobile application market as well as an online market.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific example embodiments disclosed, and that modifications to the disclosed example embodiments, as well as other example embodiments, are intended to be included within the scope of the appended claims. The present invention is defined by the following claims, with equivalents of the claims to be included therein.

What is claimed is:

1. A method for managing an online market, the method comprising:
(a) Mapping a requestor as an participant in a multi-layer and multi-branch growth model when the requestor requests to join an online market, wherein the multi-layer and multi-branch growth model is classified into a root belonging to a first layer, a leaf belonging to a bottom layer, and a branch belonging to an intermediate layer between the root and the leaf;
(b) posting a good on a Platform when the good is requested to be posted on the Platform which is provided to the participant; and
(c) sharing revenue generated in accordance with the selling of a good with a Listing participant that Lists the good, a Selling participant that sells the good and a Recruiting participant that recruits the Selling participant based on the multi-layer and multi-branch growth model, when the good is sold.

2. The method of claim 1, wherein the step (a) comprises the step of:
(a-1) checking whether or not the recruiting participant that recruits a corresponding requestor exists in the model;
(a-2) making a contract between a root manager and the corresponding requestor, when the recruiting participant is checked not to exist in the step (a-1);
(a-3) Mapping the corresponding requestor into the multi-layer and multi-branch growth model as a leaf participant; and
(a-4) providing the corresponding requestor with the Platform.

3. The method of claim 2, wherein the step (a) further comprises the step of:
(a-5) checking whether or not a corresponding recruiting participant is a leaf participant, when the recruiting participant is verified to exist in the step (a-1);
(a-6) raising the corresponding recruiting participant to a branch participant;
(a-7) making a contract between the corresponding requestor and the corresponding recruiting participant;
(a-8) Mapping the corresponding requestor into the multi-layer and multi-branch growth model as the leaf participant; and
(a-9) providing the corresponding requestor with the Platform.

4. The method of claim 1, wherein the step (c) comprises the step of:
(c-1) verifying the Listing participant that posts the good, the Selling participant that sells the corresponding good and the Recruiting participant that recruits the corresponding selling participant in the multi-layer and multi-branch growth model.

5. The method of claim 4, wherein the step (c) further comprises the step of:
(c-2) sharing the revenue with the corresponding Posting participant, the corresponding Selling participant and the corresponding Recruiting participant, when the Posting participant, the Selling participant and the Recruiting participant are verified in the step (c-1).

6. The method of claim 1, wherein sub-layers make a contract with each other subordinately to be classified into a high layer and a lower layer.

7. The method of claim 1, wherein the good is a Smartphone app.

8. An online market management system comprising:
a Role Mapping Server configured to map a requestor as an participant in a multi-layer and multi-branch growth model when the requestor requests to join an online market, wherein the multi-layer and multi-branch growth model is classified into a root belonging to a first layer, a leaf belonging to a bottom layer, and a branch belonging to an intermediate layer between the root and the leaf;
a Goods Posting Server configured to post a good on a Platform when the good is requested to be posted on the Platform which is provided to the participant; and
a Revenue Sharing Server configured to share revenue generated in accordance with a sale of the good with a posting participant that posts the good, a selling participant that sells the good and a recruiting participant that recruits the selling participant based on the multi-layer and multi-branch growth model, when the good is sold.

9. The online market management system of claim 8, wherein the Role Mapping Server comprises:
a contract conclusion module configured to make a contract between a participant in a root site business and a participant in a branch of the root site business, or to make a contract between a corresponding participant and a participant that recruits the corresponding participant;
a Platform providing module configured to provide a Platform with the participant corresponding to the branch after the contract is completed; and
a layer defining module configured to define the participant corresponding to the branch contracted with a root site business or another participant contracted with the corresponding participant as a lower layer.

10. The online market management system of claim 8, wherein the Revenue Sharing Server comprises:
an Inquiring Module configured to verify the posting participant that posts the good, to inquire the selling participant that sells the corresponding good, and to verify the recruiting participant that recruits the corresponding selling participant; and
a Sharing Module configured to share revenue as a result of posting the good to the verified posting participant, to share revenue as a result of selling the good to the inquired selling participant, and to share revenue as a result of recruiting the selling participant to the inquired recruiting participant.

11. The online market management system of claim 8, wherein the sub-layers make a contract with each other subordinately to be classified into a high layer and a lower layer.

12. The online market management system of claim 8, wherein a branch belonging to an uppermost layer receives a Platform from the root through a contract with the root.

13. The online market management system of claim 8, wherein a branch belonging to a bottom layer provides a Platform to the leaf by a contract with the leaf.

14. The online market management system of claim 8, wherein when one of the leaves recruits a requestor that requests to join the online market, the corresponding leaf is raised as the branch, and the corresponding requestor is mapped as the leaf.

15. The online market management system of claim 8, wherein the good is a Smartphone app.

16. The online market management system of claim 8, when expected revenue as a result of selling the requested good from one of the posting participant, the selling participant and the recruiting participant,
further comprising:
an Expected Revenue Calculation Server configured to calculate the expected revenue to provide the corresponding participant with the expected revenue.

17. The online market management system of claim 16, wherein a branch seller that has an inventory of the goods but does not have a selling capacity obtains expected revenue defined as F(rα+γ)NP (wherein, ‘F’ is a fee per goods, ‘r’ is the number of child branches expanded from one branch, ‘α’ is revenue sharing ratio for a recruiting activity, and ‘γ’ is revenue sharing ratio for a posting activity).

18. The online market management system of claim 16, wherein a branch seller that does not have an inventory of the goods but has a selling capacity obtains an expected revenue defined as F(rα+β)NP (wherein, ‘F’ is a fee per goods, ‘r’ is the number of child branches expanded from one branch, ‘α’ is revenue sharing ratio for a recruiting activity, ‘β’ is revenue sharing ratio according to a selling activity, ‘N’ is the total number of sites, and P=1/N²).

19. The online market management system of claim 16, wherein the expected revenue ratio of a root, a branch and a leaf is defined as (rα+1):((r−1)α+1):(1−α) (wherein, ‘r’ is the number of child branches expanded from one branch, and ‘α’ is revenue sharing ratio for a recruiting activity), and ‘α’ is a variable that may be changed in order to control the revenue ratio between the branch and the leaf.
